(19) United States
(12) Patent Application Publication
(10) Pub. No.: US 2026/0308858 A1
(43) Pub. Date: Oct. 8, 2026

(54) UNDERWATER DAM DEFECT DETECTION METHOD, SYSTEM, AND STORAGE MEDIUM

(71) Applicant: Hohai University, Changzhou (CN)

(72) Inventors: Pengfei SHI, Changzhou (CN); Yueyue LIU, Changzhou (CN); Yuanxue XIN, Changzhou (CN); Jinyun LIU, Changzhou (CN); Yingjuan XIE, Changzhou (CN); Lihua DENG, Changzhou (CN); Jianjun NI, Changzhou (CN); Changchun CAI, Changzhou (CN); Weidong CAO, Changzhou (CN); Yang GU, Changzhou (CN); Zhuo ZHANG, Changzhou (CN)

(73) Assignee: Hohai University, Changzhou (CN)

(21) Appl. No.: 19/233,325

(22) Filed: Jun. 10, 2025

(30) Foreign Application Priority Data
Mar. 26, 2025 (CN) 2025103678999

(51) Int. Cl. E02B 7/06; G06N 3/0455; G06V 20/05

(52) U.S. Cl. CPC E02B 7/06; G06N 3/0455; G06V 20/05; E02B 2201/00

(57) ABSTRACT

Disclosed is an underwater dam defect detection method, system, and storage medium, belonging to the technical field of underwater dam defect detection. The method includes: acquiring original underwater dam images; inputting the original underwater dam images into a pre-constructed defect detection model to output defect detection results. The construction of the defect detection model includes: acquiring an encoder-decoder model; replacing the output layer of the CASS module in the encoder with a dual-branch collaborative attention module, and replacing the fusion module with a dual-domain feature aggregation module to obtain the constructed defect detection model.

### CROSS-REFERENCE TO RELATED APPLICATIONS

This application claims priority to Chinese Application No. CN2025103678999, having a filing date of Mar. 26, 2025, the entire contents of which are hereby incorporated by reference.

### TECHNICAL FIELD

The present invention pertains to the technical field of underwater dam defect detection, and particularly relates to an underwater dam defect detection method, system, and storage medium.

### BACKGROUND OF THE INVENTION

In modern society, the monitoring and surveillance of critical engineering infrastructure are of paramount importance. Concrete dams, serving as core facilities for flood control, water supply, irrigation, navigation, and hydroelectric power generation, play an irreplaceable role. However, due to prolonged exposure to external static loads (e.g., hydrostatic pressure, thermal loads) and dynamic loads, combined with internal material aging, concrete dams are prone to developing defects, significantly increasing the risk of structural failure. These defects not only compromise the structural integrity of dams and alter stress distribution but may also propagate internally under hydraulic pressure, potentially triggering catastrophic consequences.

Therefore, timely and accurate defect detection and the implementation of protective measures are critical to ensuring dam safety. Traditional underwater dam defect detection primarily relies on manual visual inspections, where divers conduct visual assessments. However, this approach faces challenges such as low efficiency, significant subjective errors, susceptibility to environmental conditions, and high safety risks, making it inadequate for modern structural health monitoring demands. In recent years, computer vision and deep learning-based technologies have gradually been introduced to defect detection. Yet, due to the complexity of underwater environments (e.g., uneven lighting, noise interference, image blurring), conventional algorithms underperform in practical applications. Consequently, developing an efficient, precise, and adaptive automatic underwater dam defect detection method has become a critical challenge requiring urgent resolution in the field of structural health monitoring.

### SUMMARY OF THE INVENTION

The objective of the present invention is to overcome the limitations in existing technologies by providing an underwater dam defect detection method, system, and storage medium. This solution is capable of effectively addressing challenges in underwater environments, such as noise interference, image blurring, and uneven lighting, thereby providing reliable technical support for the safety monitoring and maintenance of underwater dams.

To achieve the above objectives, the present invention adopts the following technical solution:

On one hand, the present invention provides an underwater dam defect detection method comprising: Acquiring original underwater dam images; Inputting the original underwater dam images into a pre-constructed defect detection model and outputting dam defect detection results; where constructing the defect detection model comprises: Acquiring an encoder-decoder model; Replacing the output layer of the CASS module in the encoder with a dual-branch collaborative attention module and replacing the fusion module with a dual-domain feature aggregation module to construct the defect detection model.

Optionally, the processing steps of the defect detection model include:
In the encoder, performing Zigzag feature scanning on the original underwater dam images to obtain scanned features, and performing the dual-branch feature extraction on the scanned features via a dual-branch collaborative attention module to obtain output feature maps;
In the dual-domain feature aggregation module, performing dual-domain feature aggregation on the output feature maps to obtain aggregated features;
In the encoder, decoding and reconstructing the aggregated features to obtain dam defect detection results.

Optionally, performing Zigzag feature scanning on the original underwater dam images to obtain scanned features comprises:
Performing continuous row-wise feature scanning on the original underwater dam images to obtain horizontal scanned features;
Performing continuous column-wise feature scanning on the original underwater dam images to obtain vertical scanned features;
Dividing the original underwater dam images into multiple windows, performing feature scanning on each window to obtain local scanned features.

Optionally, the method further comprises:

when the scanning of the original underwater dam image reaches the end of a row or column, continuing feature scanning in a reversed direction for positions adjacent to the current scanning position according to a preset scan position mapping table, until all positions complete feature scanning.

Optionally, performing the dual-branch feature extraction on the scanned features to obtain output feature maps comprises:

$${F}_{g} = ℛ ( {F}_{in} , G ) ;$$

$${F}_{h} = {AvgPool}_{h} ( {F}_{g} ) , {F}_{w} = {{AvgPool}_{w} ( {F}_{g} )}^{T} ;$$

$${\tilde{F}}_{h} = σ ( Γ ( {Concat}_{k = 3 , 5 , 7} ( Conv 1 {{D}_{k} ( {F}_{h}^{( m )} )}_{m = 1}^{N} ) ) ) ;$$

$${\tilde{F}}_{w} = σ ( Γ ( {Concat}_{k = 3 , 5 , 7} ( Conv 1 {{D}_{k} ( {F}_{w}^{( m )} )}_{m = 1}^{N} ) ) ) ;$$

$${C}_{1} = {\tilde{F}}_{h} ⊙ {\tilde{F}}_{w} ⊙ {F}_{g} ;$$

$${F}_{conv} = Conv 3 \times 3 ( {F}_{g} ) ;$$

$$M = σ ( Softmax ( {C}_{1} ) ⊗ \frac{1}{H \times W} {\sum }_{\text{?}}^{\text{?}} {\sum }_{\text{?}}^{\text{?}} {F}_{\text{?}} ( i , j ) + \frac{1}{H \times W} {\sum }_{\text{?}}^{\text{?}} {\sum }_{\text{?}}^{\text{?}} {C}_{\text{?}} ( i , j ) ⊗ Softmax ( {F}_{\text{?}} ) ) ;$$

$${F}_{out} = M ⊙ {F}_{g} ;$$

$$\text{?} \text{indicates text missing or illegible when filed}$$

Where, F_{g} represents the features obtained after grouping the input feature maps; Fₕ denotes the features obtained by average pooling F_{g} along the height dimension; F_{w} denotes the features obtained by average pooling F_{g} along the width dimension; \tilde{F}ₕ denotes the features further processed from Fₕ; \tilde{F}_{w} denotes the features further processed from F_{w}; C₁ denotes the features obtained by element-wise multiplication of \tilde{F}ₖ, \tilde{F}_{w} and F_{g}; F_{conv} denotes the result of applying a 3×3 convolution to F_{g}; M denotes the generated attention weight matrix; Fₒᵤₜ denotes the output feature maps; Fᵢₙ denotes the input feature maps; G denotes the number of groups; [symbol] (•) denotes the group-wise dimension transformation operation; AvgPoolₕ(•) denotes average pooling along the height dimension; AvgPool_{w}(•) denotes average pooling along the width dimension;

$${F}_{h}^{( m )}$$

denotes the m-th sub-segment of Fₕ; N denotes the number of sub-segments; Conv1Dₖ(•) denotes a 1D convolution with a kernel size of k; Concat(•) denotes concatenation of multiple feature dimensions; k=(3,5,7) denotes different convolution kernel sizes; Γ(•) denotes GroupNorm processing; σ(•) denotes the Sigmoid activation function;

$${F}_{w}^{( m )}$$

denotes the m-th sub-segment of F_{w}; Conv3×3(•) denotes a 3×3 convolution; denotes the Softmax activation function; H [symbol] W denotes the height and width of the image; ⊙ denotes element-wise multiplication; ⊗ denotes matrix multiplication.

Optionally, performing dual-domain feature aggregation on the output feature maps to obtain aggregated features comprises:

$${S}_{1}^{fuse} = BN ( {GConv}_{3 \times 3} ( {E}_{n - k} ) ) ⊕ BN ( {GConv}_{3 \times 3} ( {D}_{k} ) ) ;$$

$${S}_{2}^{ap} = AvgPool ( AvgPool ( ReLU ( \cdot ) ) ) ;$$

$${S}_{3}^{detail} = ReLU ( BN ( Conv ( {S}_{1}^{fuse} ⊖ {S}_{2}^{ap} ) ) ) ⊕ {S}_{2}^{ap} ) ) ) ;$$

$${S}_{3}^{multiply} = ReLU ( BN ( Conv ( {S}_{1}^{fuse} ⊗ {S}_{2}^{ap} ) ) ) ;$$

$${S}_{3}^{merge} = Concat ( {S}_{3}^{multiply} , {S}_{3}^{detail} ) ;$$

$${F}_{\text{?}} = BN ( PWC ( Concat ( {S}_{1}^{fuse} , PWC ( {S}_{3}^{merge} ) ) ;$$

$${A}_{1} , {H}_{1} , {V}_{1} , {D}_{1} = DWT ( {E}_{n - k} ) ;$$

$${A}_{2} , {H}_{2} , {V}_{2} , {D}_{2} = DWT ( {D}_{k} ) ;$$

$${F}_{1}^{low} = PWC ( DWC ( {A}_{1} ) ) ⊕ PWC ( DWC ( {A}_{2} ) ) ;$$

$${F}_{2}^{high} = PWC ( Concat ( {H}_{1} , {V}_{1} , {D}_{1} ) ) ⊕ PWC ( Concat ( {H}_{2} , {V}_{2} , {D}_{2} ) ) ;$$

$${F}_{f} = BN ( IDWT ( {F}_{1}^{low} , {F}_{2}^{high} ) ⊕ {E}_{n - k} ⊕ {D}_{k} ) ;$$

$${F}_{k} = AGFS ( {F}_{\text{?}} , {F}_{f} ) ;$$

$$\text{?} \text{indicates text missing or illegible when filed}$$

where

$${S}_{1}^{fuse}$$

denotes the fused features obtained through group convolution and normalization;

$${S}_{2}^{ap}$$

denotes the features after dual average pooling;

$${S}_{3}^{detail}$$

denotes the detailed features captured by the difference branch;

$${S}_{3}^{multiply}$$

denotes the features extracted by the multiplication branch;

$${S}_{3}^{merge}$$

denotes the merged features; Fₛ denotes the spatially aggregated features;

$${F}_{1}^{low}$$

denotes the fused features of low-frequency components after concatenation and depthwise separable convolution;

$${F}_{2}^{high}$$

denotes the fused features of high-frequency components after concatenation and pointwise convolution; F_{f} denotes the features after wavelet reconstruction and residual connection; Eₙ₋ₖ denotes the encoder input features; Dₖ denotes the decoder input features; ⊕ denotes element-wise addition; GConv_{3×3}(•) denotes group convolution with a 3×3 kernel; BN(•) denotes batch normalization; ReLU(•) denotes the rectified linear unit activation function; Avgpool(•) denotes average pooling; Conv(•) denotes a standard convolution operation; Concat(•) denotes concatenation of multiple feature dimensions; PWC(•) denotes pointwise convolution; A₁ denotes the low-frequency component of encoder features; H₁ denotes the horizontal high-frequency component of encoder features; V₁ denotes the vertical high-frequency component of encoder features; D₁ denotes the diagonal high-frequency component of encoder features; A₂ denotes the low-frequency component of decoder features; H₂ denotes the horizontal high-frequency component of decoder features; V₂ denotes the vertical high-frequency component of decoder features; D₂ denotes the diagonal high-frequency component of decoder features; DWT(•) denotes discrete wavelet transform; DWC(•) denotes depthwise convolution; IDWT(•) denotes inverse discrete wavelet transform; Fₖ denotes the output feature maps; AGFS(•) denotes adaptive global feature selection.

Optionally, training of the defect detection model comprises: training the defect detection model using a weighted sum of a Binary Cross-Entropy loss function and a Dice loss function as a combined loss function, to obtain a trained defect detection model.

Optionally, the combined loss function is calculated as follows:

$${Loss}_{BCE} ( {y}^{pred} , {y}^{gt} ) = - {y}^{gt} ln {y}^{pred} + ( 1 - {y}^{gt} ) ln ( 1 - {y}^{pred} ) ;$$

$${Loss}_{Dice} ( {y}^{pred} , {y}^{gt} ) = 1 - \frac{2 \vert {y}^{pred} ⋂ {y}^{gt} \vert}{\vert {y}^{pred} \vert + \vert {y}^{gt} \vert} ;$$

$${Loss}_{Total} = {Loss}_{BCE} ( {y}^{pred} , {y}^{gt} ) + {Loss}_{Dice} ( {y}^{pred} , {y}^{gt} ) .$$

Where, Loss_{BCE}(y^{pred},y^{gt}) denotes a Binary Cross-Entropy loss function; Loss_{Dice}(y^{pred},y^{gt}) represents a Dice loss function; Loss_{Total} is a combined loss function; Loss_{Total} is a combined loss function; y^{pred} is the predicted result from the segmentation network, y^{gt} is the ground truth corresponding to the input image.

Second Aspect: The present invention provides an underwater dam defect detection system, comprising: an image acquisition module configured to acquire the original underwater dam images; an imaging detection module configured to input the original underwater dam images into a pre-constructed defect detection model and output dam defect detection results; a model processing module configured to construct the defect detection model; where the construction of the defect detection model comprises: acquiring an encoder-decoder model; replacing the output layer of the CASS module in the encoder with a dual-branch collaborative attention module; and replacing the fusion module with a dual-domain feature aggregation module to construct the defect detection model.

Third Aspect: The present invention provides a computer-readable storage medium having stored thereon computer programs which, when executed by a processor, implement the steps of the underwater dam defect detection method according to the first aspect.

Compared with prior art, the present invention achieves the following beneficial effects:

The present invention enhances defect detection accuracy and efficiency through an innovative model architecture, capable of effectively addressing challenges in underwater environments such as noise interference, image blurring, and uneven lighting. This provides a high-efficiency and precise solution for underwater dam defect detection, demonstrating significant engineering application value. The dual-branch collaborative attention module extracts both local and global features by integrating horizontal, vertical, and local scanning via the Zigzag feature scanning method, comprehensively capturing defect characteristics while adapting to complex underwater conditions. Concurrently, the dual-domain feature aggregation module optimizes features through spatial and frequency domain processing, combined with adaptive global feature selection, thereby enhancing defect edge sensitivity and model robustness.

### BRIEF DESCRIPTION OF DRAWINGS

FIG. 1 shows a schematic flowchart of the underwater dam defect detection method according to one embodiment of the present invention.

FIG. 2 illustrates the structure of a dual-branch collaborative attention module in one embodiment.

FIG. 3 presents the Zigzag feature scanning mode used in one embodiment.

FIG. 4 demonstrates the 2D selective scanning configuration.

FIG. 5 depicts the architecture of a dual-domain feature aggregation module.

FIG. 6 explains the decomposition principle of Haar wavelet transform.

FIG. 7 shows the structure of the adaptive global feature selection module.

### DETAILED DESCRIPTION OF THE INVENTION

The technical solutions of the present invention are described in detail below with reference to the accompanying drawings and specific embodiments. It should be understood that the embodiments of the present invention and the specific features therein provide a detailed explanation of the technical solutions, rather than limiting their scope. Under circumstances without conflict, the embodiments and technical features described herein may be mutually combined.

The term “and/or” merely describes an associative relationship between related objects, indicating that three types of relationships may exist. For example, “A and/or B” may represent: the existence of A alone, the coexistence of A and B, or the existence of B alone. Additionally, the character “/” generally indicates that the preceding and following related objects have an “or” relationship.

### Embodiment 1

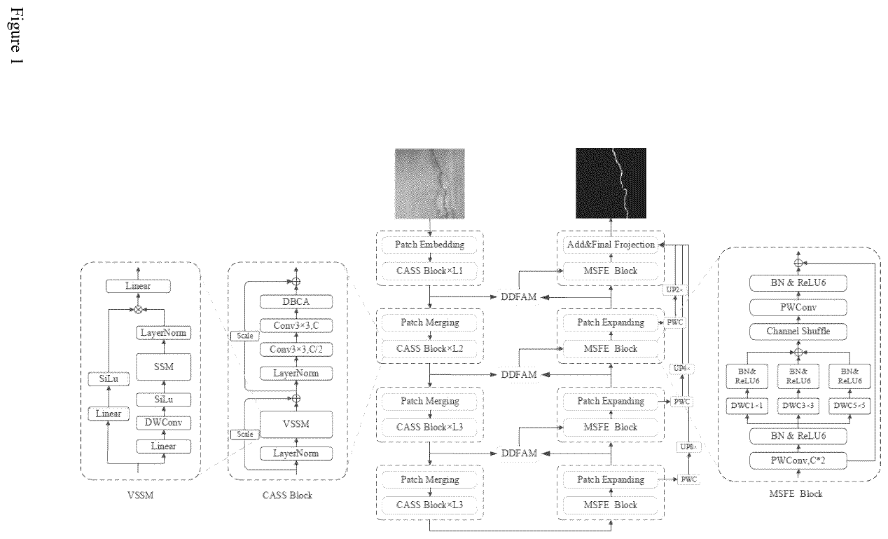

As shown in FIG. 1, the present embodiment discloses an underwater dam defect detection method designed to address the limitations of traditional approaches, including low efficiency, insufficient accuracy, and poor adaptability to complex environments. This method effectively tackles challenges in underwater environments such as noise interference, image blurring, and uneven lighting, thereby providing reliable technical support for the safety monitoring and maintenance of underwater dams.

The method comprises the following steps:

Step 1: Acquiring the original underwater dam images. Specifically:

An authentic dataset specifically designed for underwater dam defect detection was constructed, containing 250 images captured directly from underwater dam environments. These images underwent frame-by-frame screening and were meticulously annotated with defect instances using annotation tools, thereby ensuring data accuracy.

Data augmentation was performed on the original underwater dam images, including operations such as rotation, cropping, and horizontal flipping, to simulate the appearance of defects under varying angles and scales, thereby enhancing data diversity.

The final dataset comprises 1,216 images, each with a unified resolution of 448×448 pixels. This self-constructed dataset provides critical data support for underwater defect detection tasks.

Step 2: Inputting the original underwater dam defect images into the pre-constructed defect detection model and outputting dam defect detection results.

### Specifically:

The defect detection model is improved based on an encoder-decoder architecture, where the output layer of the CASS module in the encoder is replaced with a dual-branch collaborative attention module; The fusion module is replaced with a dual-domain feature aggregation module, thereby acquiring the constructed defect detection model.

The encoder progressively constructs hierarchical feature representations through a multi-stage network, where each stage comprises a downsampling layer and multiple collaborative attention state space (CASS) modules. Spatial and frequency domain features are fused via a Dual-Domain Feature Aggregation Module, integrating encoder and decoder features. Finally, the decoder employs multi-scale convolutional modules to refine encoder features, followed by pointwise convolution and upsampling operations on each decoder branch output. These processed features are element-wise summed to generate the final detection results. This multi-branch fusion strategy significantly enhances multi-scale feature representation capability, improving both defect detection accuracy and consistency.

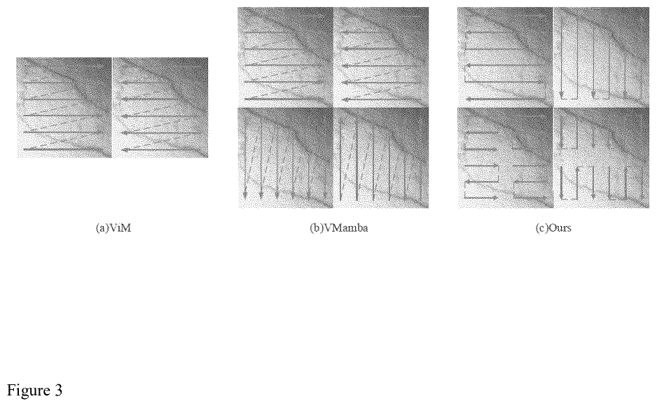

First, within the state-space model (SSM) of the encoder, to address the limitations of conventional scanning methods in defect feature extraction, the present embodiment proposes a Zigzag Feature Scanning Strategy, as illustrated in FIG. 3. This strategy integrates three distinct feature scanning modes: horizontal, vertical, and local scanning, comprehensively capturing defect characteristics from multiple perspectives. The resulting outputs include horizontal scanned features, vertical scanned features, and local scanned features:

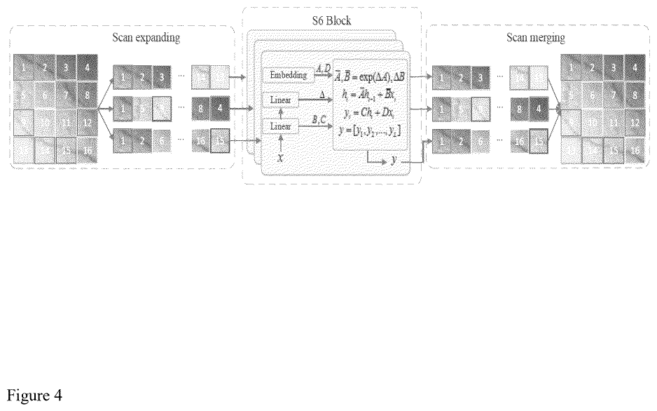

As shown in FIG. 4, the horizontal feature scanning performs continuous row-wise feature scanning on the original underwater dam images to capture horizontally extended defect features, thereby reducing information discontinuity caused by cross-row jumps. The vertical feature scanning conducts continuous column-wise feature scanning on the original images to target vertically oriented defects, addressing the weakened vertical correlations inherent in traditional horizontal scanning. The local feature scanning divides the original images into multiple local windows and executes high-density scanning within each window, thus enhancing sensitivity to subtle defects and complex topological structures.

During the scanning process, when the scanning reaches the end of a row or column of the original underwater dam images, the direction is reversed according to a preset scan position mapping table to continue feature scanning at positions adjacent to the current scanning location. This iterative process persists until all positions undergo feature scanning. This strategy not only ensures scanning efficiency but also significantly enhances the capability to capture defect features, particularly suited for defect detection tasks in complex underwater environments.

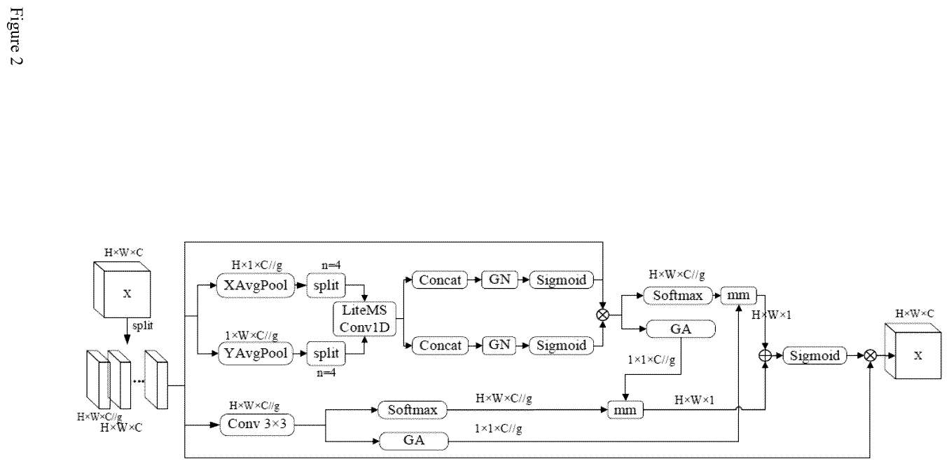

Second, as shown in FIG. 2, within the dual-branch collaborative attention module of the encoder: Group-wise processing is first applied to the input feature maps to reduce parameter count and mitigate inter-channel over-coupling. Bidirectional pooling is then performed to capture horizontal and vertical directional feature responses, reinforcing the linear structural characteristics of defects. The pooled results are segmented into multiple sub-sections, followed by 1D convolutional operations with varying receptive fields to capture multi-scale features. Feature contributions are adaptively adjusted through learnable weights, thereby significantly enhancing the extraction and representation capabilities for defect features in complex underwater environments. Specifically: the processing is

$${F}_{g} = ℛ ( {F}_{i n} , G ) ;$$

$${F}_{h} = {AvgPool}_{h} ( {F}_{g} ) , {F}_{w} = {{AvgPool}_{w} ( {F}_{g} )}^{⊤} ;$$

$${\tilde{F}}_{h} = σ ( Γ ( {Concat}_{k = 3 , 5 , 7} ( Conv 1 {{D}_{k} ( {F}_{h}^{( m )} )}_{m = 1}^{N} ) ) ) ;$$

$${\tilde{F}}_{h} = σ ( Γ ( {Concat}_{k = 3 , 5 , 7} ( Conv 1 {{D}_{k} ( {F}_{w}^{( m )} )}_{m = 1}^{N} ) ) ) .$$

The DBCA module is a dual-branch feature extraction module that processes the scanned features through two parallel branches to generate output feature maps. Main Branch: Fuses weighted features using directional attention mechanisms and global contextual information to reinforce structural consistency; Auxiliary Branch: Extracts fine-grained local features via localized convolutions, correcting regional response deviations; Cross-Branch Fusion: Achieves collaborative attention integration through matrix multiplication between branch outputs, generating a final attention map. This map is then element-wise multiplied with the grouped feature maps to produce the final output. By leveraging this dual-branch complementary mechanism, the module balances global semantics and local details, thereby significantly improving defect detection performance. Specifically: the processing is

$${C}_{1} = {\tilde{F}}_{h} ⊙ {\tilde{F}}_{w} ⊙ {F}_{g} ;$$

$${F}_{conv} = Conv 3 \times ( {F}_{g} ) ;$$

$${S}_{1} = Softmax ( {C}_{1} ) ;$$

$${G}_{1} = \frac{1}{H \times W} {\sum }_{i = 1}^{H} {\sum }_{j = 1}^{W} {C}_{1} ( i , j ) ;$$

$${S}_{2} = Softmax ( {F}_{conv} ) ;$$

$${G}_{2} = \frac{1}{H \times W} {\sum }_{i = 1}^{H} {\sum }_{j = 1}^{W} {F}_{conv} ( i , j ) ;$$

$$M = σ ( {S}_{1} ⊗ {G}_{2} + {G}_{1} ⊗ {S}_{2} ) ;$$

$${F}_{out} = M ⊙ {F}_{g} .$$

Where, F_{g} represents the features obtained after grouping the input feature maps; Fₕ denotes the features obtained by average pooling F_{g} along the height dimension; F_{w} denotes the features obtained by average pooling F_{g} along the width dimension; \tilde{F}ₕ denotes the features further processed from Fₕ; \tilde{F}_{w} denotes the features further processed from F_{w}; C₁ denotes the features obtained by element-wise multiplication of \tilde{F}ₖ, \tilde{F}_{w} and F_{g}; F_{conv} denotes the result of applying a 3×3 convolution to F_{g}; M denotes the generated attention weight matrix; Fₒᵤₜ denotes the output feature maps; Fᵢₙ denotes the input feature maps; G denotes the number of groups; [symbol] (•) denotes the group-wise dimension transformation operation; AvgPoolₕ(•) denotes average pooling along the height dimension; AvgPool_{w}(•) denotes average pooling along the width dimension;

$${F}_{h}^{( m )}$$

denotes the m-th sub-segment of Fₕ; N denotes the number of sub-segments; Conv1Dₖ(•) denotes a 1D convolution with a kernel size of k; Concat(•) denotes concatenation of multiple feature dimensions; k=(3,5,7) denotes different convolution kernel sizes; Γ(•) denotes GroupNorm processing; σ(•) denotes the Sigmoid activation function;

$${F}_{w}^{( m )}$$

denotes the m-th sub-segment of F_{w}; Conv3×3(•) denotes a 3×3 convolution; Softmax(•) denotes the Softmax activation function; H [symbol] W denotes the height and width of the image; ⊙ denotes element-wise multiplication; ⊗ denotes matrix multiplication.

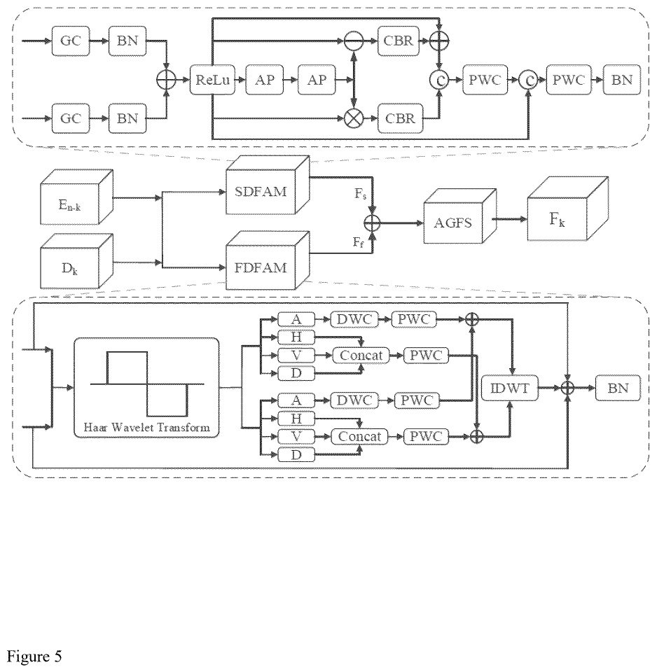

Then, as shown in FIG. 5, to address the limitations of traditional fusion module in underwater defect detection tasks, this embodiment proposes a dual-domain feature aggregation module. This module optimizes features from both spatial and frequency domain through a spatial domain feature aggregation module and a frequency domain feature aggregation module, respectively. Subsequently, an Adaptive Global Feature Selection (AGFS) module is employed to achieve semantic alignment between spatial and frequency domain features, thereby enhancing the accuracy of foreground feature extraction.

The spatial domain feature aggregation module adopts a dual-branch design: a difference branch captures edge detail variations, while a product branch strengthens macro-region feature modeling, significantly improving sensitivity to defect edges and the ability to recognize structural continuity. Specifically: the processing is

$${S}_{1}^{fuse} = BN ( {GConv}_{3 \times 3} ( {E}_{n - k} ) ) ⊕ BN ( {GConv}_{3 \times 3} ( {D}_{k} ) ) ;$$

$${S}_{2}^{up} = AvgPool ( AvgPool ( ReLU ) ( \cdot ) ) ) ;$$

$${S}_{3}^{detail} = ReLU ( BN ( Conv ( {S}_{1}^{fuse} ⊖ {S}_{2}^{up} ) ) ) ⊕ {S}_{1}^{fuse} ;$$

$${S}_{3}^{multiply} = ReLU ( BN ( Conv ( {S}_{1}^{fuse} ⊗ {S}_{2}^{up} ) ) ) ;$$

$${S}_{3}^{merge} = Concat ( {S}_{3}^{multiply} , {S}_{3}^{detail} ) ;$$

$${F}_{s} = BN ( PWC ( Concat ( {S}_{1}^{fuse} , PWC ( {S}_{3}^{merge} ) ) .$$

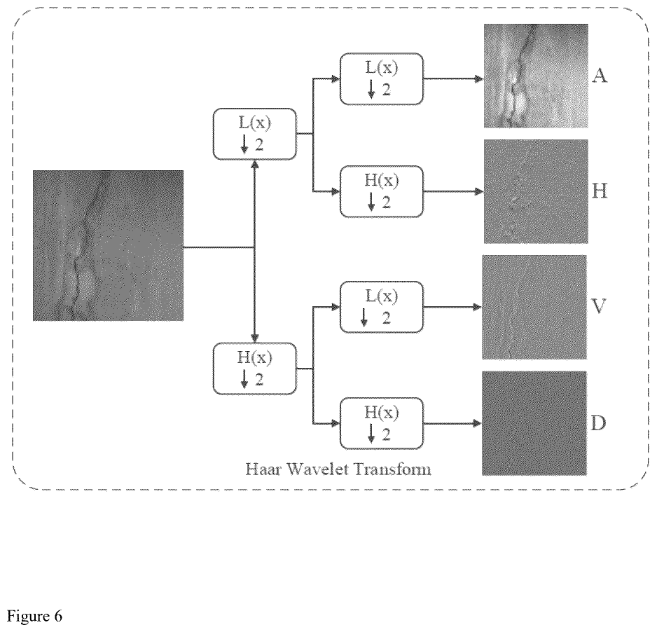

The frequency domain feature aggregation module employs wavelet transform to decompose features into low-frequency and high-frequency components for separate processing. As illustrated in FIG. 6, this approach effectively suppresses noise interference while enhancing adaptability to irregular defects. Formally expressed:

$${A}_{1} , {H}_{1} , {V}_{1} , {D}_{1} = DWT ( {E}_{n - k} ) ;$$

$${A}_{2} , {H}_{2} , {V}_{2} , {D}_{2} = DWT ( {D}_{k} ) ;$$

$${F}_{1}^{low} = PWC ( DWC ( {A}_{1} ) ) ⊕ PWC ( DWC ( {A}_{w} ) ) ;$$

$${F}_{2}^{high} = PWC ( Concat ( {H}_{1} , {V}_{1} , {D}_{1} ) ) ⊕ PWC ( Concat ( {H}_{2} , {V}_{2} , {D}_{2} ) ) ;$$

$${F}_{d} = BN ( IDWT ( {F}_{1}^{low} , {F}_{high}^{2} ) ⊕ {E}_{n - k} ⊕ {D}_{k} ) .$$

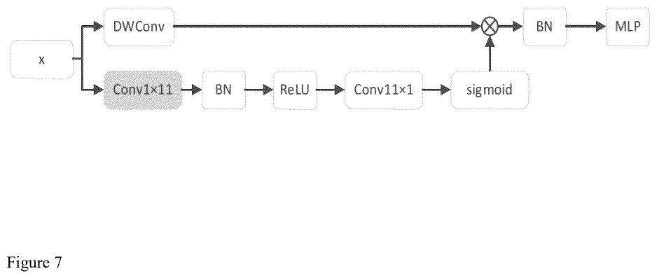

As shown in FIG. 7, the AGFS module achieves semantic alignment between spatial-domain and frequency-domain features while optimizing foreground feature extraction accuracy. Formally expressed:

$${F}_{k} = AGFS ( {F}_{s} , {F}_{f} ) .$$

where,

$${S}_{1}^{fuse}$$

denotes the fused features obtained through group convolution and normalization;

$${S}_{2}^{ap}$$

denotes the features after dual average pooling;

$${S}_{3}^{detail}$$

denotes the detailed features captured by the difference branch;

$${S}_{3}^{multiply}$$

denotes the features extracted by the multiplication branch;

$${S}_{3}^{merge}$$

denotes the merged features; Fₛ denotes the spatially aggregated features;

$${F}_{1}^{low}$$

denotes the fused features of low-frequency components after concatenation and depthwise separable convolution;

$${F}_{2}^{high}$$

denotes the fused features of high-frequency components after concatenation and pointwise convolution; F_{f} denotes the features after wavelet reconstruction and residual connection; Eₙ₋ₖ denotes the encoder input features; Dₖ denotes the decoder input features; ⊕ denotes element-wise addition; GConv_{3×3}(•) denotes group convolution with a 3×3 kernel; BN(•) denotes batch normalization; ReLU(•) denotes the rectified linear unit activation function; AvgPool(•) denotes average pooling; Conv(•) denotes a standard convolution operation; Concat(•) denotes concatenation of multiple feature dimensions; PWC(•) denotes pointwise convolution; A₁ denotes the low-frequency component of encoder features; H₁ denotes the horizontal high-frequency component of encoder features; V₁ denotes the vertical high-frequency component of encoder features; D₁ denotes the diagonal high-frequency component of encoder features; A₂ denotes the low-frequency component of decoder features; H₂ denotes the horizontal high-frequency component of decoder features; V₂ denotes the vertical high-frequency component of decoder features; D₂ denotes the diagonal high-frequency component of decoder features; DWT(•) denotes discrete wavelet transform; DWC(•) denotes depthwise convolution; IDWT(•) denotes inverse discrete wavelet transform; Fₖ denotes the output feature maps; AGFS(•) denotes adaptive global feature selection.

The DBCA module balances global and local features, significantly enhancing the model's ability to capture defect characteristics in complex underwater environments and improving its robustness. This innovative design provides a powerful and efficient solution for underwater defect detection tasks.

Finally, the aggregated features are decoded and reconstructed by the decoder to obtain the dam defect detection results.

The training of the defect detection model includes:

We adopt a weighted sum of a Binary Cross-Entropy loss (BCE Loss) function and a Dice loss function as a combined loss function. Since defect detection is essentially a binary classification task, where pixels are divided into defect and non-defect categories. We employ BCE Loss in the loss function. BCE Loss provides fine-grained optimization signals by comparing predictions with ground truth labels pixel by pixel. Additionally, in underwater dam defect detection tasks, severe class imbalance may cause the model to overly favor non-defect pixels. To address this, we introduce Dice Loss, which directly optimizes the regional similarity between predictions and ground truth, effectively mitigating the class imbalance issue.

To leverage the advantages of both loss functions, we combine them in a weighted manner. This combined loss function effectively tackles class imbalance while simultaneously optimizing detection accuracy and boundary consistency. It enhances pixel-level classification precision and demonstrates strong robustness in handling ambiguous boundary issues. The formula for the combined loss function is as follows:

$${Loss}_{BCE} ( {y}^{pred} , {y}^{gt} ) = - {y}^{gt} ln {y}^{pred} + ( 1 - {y}^{gt} ) ln ( 1 - {y}^{pred} ) ;$$

$${Loss}_{Dice} ( {y}^{pred} , {y}^{gt} ) = 1 - \frac{2 \vert {y}^{pred} ⋂ {y}^{gt} \vert}{\vert {y}^{pred} \vert + \vert {y}^{gt} \vert} ;$$

$${Loss}_{Total} = {Loss}_{BCE} ( {y}^{pred} , {y}^{gt} ) + {Loss}_{Dice} ( {y}^{pred} , {y}^{gt} ) .$$

Where, Loss_{BCE}(y^{pred},y^{gt}) denotes a Binary Cross-Entropy loss function; Loss_{Dice}(y^{pred},y^{gt}) represents a Dice loss function; Loss_{Total} is a combined loss function; y^{pred} is the predicted result from the segmentation network, y^{gt} is the ground truth corresponding to the input image.

During the training process of this embodiment, the batch size is set to 8 with a total of 300 training epochs. The Adam algorithm is employed to optimize model parameters, incorporating a warm-up technique to ensure the learning rate gradually increases to the preset value, thereby avoiding early overfitting issues.

The defect detection method in this embodiment demonstrates outstanding performance in underwater dam image defect detection: the model achieves an IoU of 75.74% and a Dice score of 86.19%, surpassing methods such as Unet, DeepLabv3+, FADC, Mask2 former, and PEM. Particularly in small-scale defect detection, it exhibits unique precision and adaptability, effectively identifying defects of varying morphologies and sizes in complex underwater environments.

### Embodiment 2

Building upon Embodiment 1, this embodiment introduces an underwater dam defect detection system comprising:

Image Acquisition Module, configured to acquire the original underwater dam images;

Imaging Detection Module, configured to input the original underwater dam images into a pre-constructed defect detection model and outputs dam defect detection results;

Model Construction Module, configured to construct the defect detection model through the following steps:
Acquire an encoder-decoder model;
Replace the output layer of the CASS module in the encoder with a dual-branch collaborative attention module; Replace the fusion module with a dual-domain feature aggregation module to finalize the defect detection model.

The specific implementations of the aforementioned modules correspond to the relevant content described in Embodiment 1 or 2 and are not reiterated here.

### Embodiment 3

This embodiment describes a computer-readable storage medium having stored thereon a computer program which, when executed by a processor, implements the steps of the underwater dam defect detection method described in Embodiment 1.

Those skilled in the art should understand that the embodiments of the present application may be provided as methods, systems, or computer program products. Accordingly, the present application may take the form of an entirely hardware embodiment, an entirely software embodiment, or an embodiment combining software and hardware aspects. Furthermore, the present application may take the form of a computer program product implemented on one or more computer-usable storage media (including but not limited to disk storage, CD-ROM, optical storage, etc.) containing computer-usable program code.

This application is described with reference to flowcharts and/or block diagrams of methods, apparatuses (systems), and computer program products according to embodiments of the present invention. It should be understood that each process and/or block in the flowchart and/or block diagram, as well as combinations of processes and/or blocks in the flowchart and/or block diagram, may be implemented by computer program instructions. These computer program instructions may be provided to a processor of a general-purpose computer, special-purpose computer, embedded processor, or other programmable data processing device to produce a machine, such that the instructions executed by the processor of the computer or other programmable data processing device create means for implementing the functions specified in one or more processes of the flowchart and/or one or more blocks of the block diagram.

Such computer program instructions may also be stored in a computer-readable memory that can direct a computer or other programmable data processing device to function in a particular manner, such that the instructions stored in the computer-readable memory produce an article of manufacture including instruction means which implement the functions specified in one or more processes of the flowchart and/or one or more blocks of the block diagram.

The computer program instructions may also be loaded onto a computer or other programmable data processing device to cause a series of operational steps to be performed on the computer or other programmable device to produce computer-implemented processing, such that the instructions executed on the computer or other programmable device provide steps for implementing the functions specified in one or more processes of the flowchart and/or one or more blocks of the block diagram.

The embodiments of the present invention have been described above with reference to the accompanying drawings. However, the present invention is not limited to the specific embodiments described above, which are merely illustrative rather than restrictive. Under the inspiration of the present invention, those of ordinary skill in the art may make various modifications without departing from the spirit and scope of the invention as defined by the appended claims. All such modifications shall fall within the protection scope of the present invention.

1. An underwater dam defect detection method, comprising:
acquiring original underwater dam images;
inputting the original underwater dam images into a pre-constructed defect detection model to output dam defect detection results;
where the construction of the defect detection model comprises:
acquiring an encoder-decoder model;
replacing the output layer of the CASS module in the encoder with a dual-branch collaborative attention module, and replacing the fusion module with a dual-domain feature aggregation module to obtain the constructed defect detection model.

2. The underwater dam defect detection method according to claim 1, characterized in that the processing steps of the defect detection model comprise:
performing Zigzag feature scanning on the original underwater dam images in the encoder to obtain scanned features, and performing dual-branch feature extraction on the scanned features through a dual-branch collaborative attention module to obtain output feature maps;
performing dual-domain feature aggregation on the output feature maps in the dual-domain feature aggregation module to obtain aggregated features;
decoding and reconstructing the aggregated features in the decoder to obtain dam defect detection results.

3. The underwater dam defect detection method according to claim 2, characterized in that the Zigzag feature scanning of the original underwater dam images to obtain scanned features comprises:
performing continuous row-wise feature scanning on the original underwater dam images to obtain horizontal scanned features;
performing continuous column-wise feature scanning on the original underwater dam images to obtain vertical scanned features;
dividing the original underwater dam images into multiple windows, and performing feature scanning on each window to obtain local scanned features.

4. The underwater dam defect detection method according to claim 3, characterized by comprising:
when the original underwater dam images is scanned to the end of a row or column, reversing the direction based on a preset scan position mapping table and continuing feature scanning on adjacent positions until all positions are scanned.

5. The underwater dam defect detection method according to claim 2, characterized in that the dual-branch feature extraction on the scanned features to obtain the output feature maps comprises:
$${F}_{g} = ℛ ( {F}_{i n} , G ) ;$$
$${F}_{h} = {AvgPool}_{h} ( {F}_{g} ) , ( {F}_{w} = {{AvgPool}_{w} ( {F}_{h} )}^{⊤} ; )$$
$${\tilde{F}}_{h} = σ ( Γ ( {Concat}_{k = 3 , 5 , 7} ( Conv 1 {{D}_{k} ( {F}_{h}^{( m )} )}_{m = 1}^{N} ) ) ) ;$$
$${\tilde{F}}_{w} = σ ( Γ ( {Concat}_{k = 3 , 5 , 7} ( Conv 1 {{D}_{k} ( {F}_{w}^{( m )} )}_{m = 1}^{N} ) ) ) ;$$
$${C}_{1} = {\tilde{F}}_{h} ⊙ {\tilde{F}}_{w} ⊙ {\tilde{F}}_{g} ;$$
$${F}_{conv} = Conv 3 \times 3 ( {F}_{g} ) ;$$
$$M = σ ( Softmax ( {C}_{1} ) ⊗ \frac{1}{H \times W} {\sum }_{i = 1}^{H} {\sum }_{j = 1}^{W} {F}_{conv} ( i , j ) + \frac{1}{H \times W} {\sum }_{i = 1}^{H} {\sum }_{j = 1}^{W} {C}_{1} ( i , j ) ⊗ Softmax ( {F}_{conv} ) ) ;$$
$${F}_{out} = M ⊙ {F}_{g} ;$$
where, F_{g} represents the features obtained after grouping the input feature maps; Fₕ denotes the features obtained by average pooling F_{g} along the height dimension; F_{w} denotes the features obtained by average pooling F_{g} along the width dimension; \tilde{F}ₕ denotes the features further processed from Fₕ; \tilde{F}_{w} denotes the features further processed from F_{w}; C₁ denotes the features obtained by element-wise multiplication of \tilde{F}ₕ, \tilde{F}_{w} and F_{g}; F_{conv} denotes the result of applying a 3×3 convolution to F_{g}; M denotes the generated attention weight matrix; Fₒᵤₜ denotes the output feature maps; Fᵢₙ denotes the input feature maps; G denotes the number of groups; [symbol] (•) denotes the group-wise dimension transformation operation; AvgPoolₕ(•) denotes average pooling along the height dimension; AvgPool_{w}(•) denotes average pooling along the width dimension;
$${F}_{h}^{( m )}$$
denotes the m-th sub-segment of Fₕ; N denotes the number of sub-segments; Conv1Dₖ(•) denotes a 1D convolution with a kernel size of k; Concat(•) denotes concatenation of multiple feature dimensions; k=(3,5,7) denotes different convolution kernel sizes; Γ(•) denotes GroupNorm processing; σ(•) denotes the Sigmoid activation function;
$${F}_{w}^{( m )}$$
denotes the m-th sub-segment of F_{w}; Conv3×3(•) denotes a 3×3 convolution; Softmax(•) denotes the Softmax activation function; H [symbol] W denotes the height and width of the image; ⊙ denotes element-wise multiplication; ⊗ denotes matrix multiplication.

6. The underwater dam defect detection method according to claim 2, characterized in that performing dual-domain feature aggregation on the output feature maps to obtain aggregated features comprises:
$${S}_{1}^{fuse} = BN ( {GConv}_{3 \times 3} ( {E}_{n - k} ) ) ⊕ BN ( {GConv}_{3 \times 3} ( {D}_{k} ) ) ;$$
$${S}_{2}^{ap} = AvgPool ( AvgPool ( ReLU ( \cdot ) ) ) ;$$
$${S}_{3}^{detail} = ReLU ( BN ( Conv ( {S}_{1}^{fuse} ⊖ {S}_{2}^{ap} ) ) ) ⊕ {S}_{1}^{fuse} ;$$
$${S}_{3}^{multiply} = ReLU ( BN ( Conv ( {S}_{1}^{fuse} ⊗ {S}_{2}^{ap} ) ) ) ;$$
$${S}_{3}^{merge} = Concat ( {S}_{3}^{multiply} , {S}_{3}^{detail} ) ;$$
$${F}_{s} = BN ( PWC ( Concat ( {S}_{1}^{fuse} , PWC ( {S}_{3}^{merge} ) ) ;$$
$${A}_{1} , {H}_{1} , {V}_{1} , {D}_{1} = DWT ( {E}_{n - k} ) ;$$
$${A}_{2} , {H}_{2} , {V}_{2} , {D}_{2} = DWT ( {D}_{k} ) ;$$
$${F}_{1}^{low} = PWC ( DWC ( {A}_{1} ) ) ⊕ PWC ( DWC ( {A}_{2} ) ) ;$$
$${F}_{2}^{high} = PWC ( Concat ( {H}_{1} , {V}_{1} , {D}_{1} ) ) ⊕ PWC ( Concat ( {H}_{2} , {V}_{2} , {D}_{2} ) ) ;$$
$${F}_{f} = BN ( IDWT ( {F}_{1}^{low} , {F}_{2}^{high} ) ⊕ {E}_{n - k} ⊕ {D}_{k} ) ;$$
$${F}_{k} = AGFS ( {F}_{s} , {F}_{f} ) ;$$
where,
$${S}_{1}^{fuse}$$
denotes the fused features obtained through group convolution and normalization;
$${S}_{2}^{ap}$$
denotes the features after dual average pooling;
$${S}_{3}^{detail}$$
denotes detailed features captured by the difference branch;
$${S}_{3}^{multiply}$$
denotes the features extracted by the multiplication branch;
$${S}_{3}^{merge}$$
denotes the merged features; F_{g} denotes the spatially aggregated features;
$${F}_{1}^{low}$$
denotes the fused features of low-frequency components after concatenation and depthwise separable convolution;
$${F}_{2}^{high}$$
denotes the fused features of high-frequency components after concatenation and pointwise convolution; F_{f} denotes the features after wavelet reconstruction and residual connection; Eₙ₋ₖ denotes the encoder input features; Dₖ denotes the decoder input features; ⊕ denotes element-wise addition; GConov_{3×3}(•) denotes group convolution with a 3×3 kernel; BN(•) denotes batch normalization; ReLU(•) denotes the rectified linear unit activation function; AvgPool(•) denotes average pooling; Conv(•) denotes a standard convolution operation; Concat(•) denotes concatenation of multiple feature dimensions; PWC(•) denotes pointwise convolution; A₁ denotes the low-frequency component of encoder features; H₁ denotes the horizontal high-frequency component of encoder features; V₁ denotes the vertical high-frequency component of encoder features; D₁ denotes the diagonal high-frequency component of encoder features; A₂ denotes the low-frequency component of decoder features; H₂ denotes the horizontal high-frequency component of decoder features; V₂ denotes the vertical high-frequency component of decoder features; D₂ denotes the diagonal high-frequency component of decoder features; DWT(•) denotes discrete wavelet transform; DWC(•) denotes depthwise convolution; IDWT(•) denotes inverse discrete wavelet transform; Fₖ denotes the output feature maps; AGFS(•) denotes adaptive global feature selection.

7. The underwater dam defect detection method according to claim 1, characterized in that the training of the defect detection model comprises:
training the defect detection model using a weighted sum of a Binary Cross-Entropy loss function and a Dice loss function as a combined loss function, to obtain a trained defect detection model.

8. The underwater dam defect detection method according to claim 7, characterized in that the combined loss function is calculated by:
$${Loss}_{BCE} ( {y}^{pred} , {y}^{gt} ) = - {y}^{gt} ln {y}^{pred} + ( 1 - {y}^{gt} ) ln ( 1 - {y}^{pred} ) ;$$
$${Loss}_{Dice} ( {y}^{pred} , {y}^{gt} ) = 1 - \frac{2 \vert {y}^{pred} ⋂ {y}^{gt} \vert}{\vert {y}^{pred} \vert + \vert {y}^{gt} \vert} ;$$
$${Loss}_{Total} = {Loss}_{BCE} ( {y}^{pred} , {y}^{gt} ) + {Loss}_{Dice} ( {y}^{pred} , {y}^{gt} ) .$$
where, Loss_{BCE}(y^{pred},y^{gt}) denotes a Binary Cross-Entropy loss function; Loss_{Dice}(y^{pred},y^{gt}) represents a Dice loss function; Loss_{Total} is a combined loss function; y^{pred} is the predicted result from the segmentation network, y^{gt} is the ground truth corresponding to the input image.

9. An underwater dam defect detection system, characterized by comprising:
an image acquisition module configured to acquire original underwater dam images;
an imaging detection module configured to input the original underwater dam images into a pre-constructed defect detection model and output dam defect detection results;
a model construction module configured to construct the defect detection model; where the construction of the defect detection model comprises:
acquiring an encoder-decoder model;
replacing the output layer of the CASS module in the encoder with a dual-branch collaborative attention module; and replacing the fusion module with a dual-domain feature aggregation module to construct the defect detection model.

10. A computer-readable storage medium having stored thereon computer programs, characterized in that when executed by a processor, the computer programs implement the steps of the underwater dam defect detection method according to claim 1.
